(19) United States
(12) Patent Application Publication
(10) Pub. No.: US 2016/0320755 A1
(43) Pub. Date: Nov. 3, 2016

(54) WIRELESS MUSIC SYSTEM AND METHOD FOR SETTING ALARM CLOCK OF WIRELESS MUSIC SYSTEM

(71) Applicant: GUANG DONG OPPO MOBILE TELECOMMUNICATIONS CORP., LTD., Dongguan (CN)

(72) Inventor: Shangbo LIN, Dongguan (CN)

(21) Appl. No.: 15/173,901

(22) Filed: Jun. 6, 2016

Related U.S. Application Data
(63) Continuation of application No. PCT/CN2015/096057, filed on Nov. 30, 2015.

(30) Foreign Application Priority Data
Dec. 29, 2014 (CN) 201410833869.4

(51) Int. Cl. G04G 13/02; G06F 3/16

(52) U.S. Cl. CPC G04G 13/021; G06F 3/16

(57) ABSTRACT

The present disclosure provides a wireless music system and a method for setting an alarm clock of a wireless music system. The method comprises: acquiring an identification and alarm clock information of a control terminal automatically upon detecting an access of the control terminal by the wireless music system; establishing an association between the identification and the alarm clock information and storing the association in the system; and acquiring updated alarm clock information of the control terminal upon detecting an update of the alarm clock information of the control terminal, and updating the alarm clock information associated with the control terminal in the system. Through the technical solution of the present disclosure, the alarm clock information of the control terminal can be synchronized to the system automatically when the control terminal accessing to the system so as to update the alarm clock of the system in time.

### CROSS REFERENCE TO RELATED APPLICATIONS

This application is a continuation of International Application No. PCT/CN2015/096057, entitled “METHOD AND SYSTEM FOR SETTING ALARM CLOCK OF WIRELESS MUSIC SYSTEM”, field on Nov. 30, 2015, which claims the priority based on Chinese patent application No. 201410833869.4 by Guang Dong OPPO Mobile Telecommunications Co., Ltd., filed on Dec. 29, 2014, and entitled “METHOD AND SYSTEM FOR SETTING ALARM CLOCK OF WIRELESS MUSIC SYSTEM”, which disclosures are herein incorporated by reference.

### TECHNICAL FIELD

The present disclosure relates to the technical field of wireless music system, and particularly to a wireless music system and a method for setting an alarm clock of a wireless music system.

### BACKGROUND

With the development of control terminal technology and wireless transmission technology, wireless music system is becoming more and more popular. For example, in a SONOS wireless intelligent audio system, a plurality of playback devices (such as wireless speakers) are connected to form a private network by wireless means (such as IEEE802.11 and other industrial standards), wherein the playback devices can be placed at different places (such as living room, bedroom, study room, and the like) at home because of the wireless connection.

A private network of the wireless music system is typically provided with an Internet oriented export(s) which can be connected to one or more routers, and the plurality of playback devices within the private network can have access to network music resources through the exports.

Correspondingly, an application software for the wireless music system is installed in the control terminal (such as smart phone, tablet PC, and the like), and users can access and manage the plurality of playback devices within the wireless music system through the control terminal. For example, the user can increase or decrease the number of playback devices for playing music synchronously, that is to say, the user can control a single playback device to play music or control all playback devices to play music cooperatively, or, the user can make some of the playback devices as a team and control the playback devices within the team to play music synchronously. For instance, the user can make the playback devices placed at the living room as a team and play music, here, the playback devices placed at the bedroom, etc. will not involved in music playing. Besides, various control of the playback devices within the wireless music system can also be achieved through the control terminal, such as searching music, creating a play list, start/pause, and selecting the next song/last song, etc.

An alarm clock function can be arranged in the wireless music system to play music or ring tone (namely, bell) at a preset time point.

### SUMMARY

The present disclosure aims to provide a wireless music system and a method for setting an alarm clock of a wireless music system, which can synchronize the alarm clock information in a control terminal to the wireless music system automatically when the control terminal accessing to the system, and update the alarm clock of the wireless music system in time.

For this purpose, the present disclosure adopts the following technical schemes.

According to a first aspect of the present disclosure, it is provided a method for setting an alarm clock of a wireless music system, which includes: acquiring an identification (hereinafter, ID) and alarm clock information of a control terminal automatically upon detecting an access of the control terminal by the wireless music system; establishing an association between the ID and the alarm clock information and storing the association in the wireless music system; and acquiring updated alarm clock information of the control terminal upon detecting an update of the alarm clock information of the control terminal; updating the alarm clock information associated with the control terminal in the wireless music system.

In at least one embodiment, the alarm clock information includes alarm clock time and alarm clock bell. After the process of storing the association in the wireless music system, the method further includes: determining whether the control terminal is currently in an access state when the alarm clock time arrives, and if yes, playing the alarm clock bell via the wireless music system.

In at least one embodiment, the alarm clock information includes alarm clock time. The process of storing the association in the wireless music system includes: inquiring the historical play record corresponding to the ID stored in the wireless music system, and finding the most-played song of the control terminal with the ID in the wireless music system; establishing a corresponding relationship between the song and the alarm clock information, and storing the association and the corresponding relationship in the wireless music system. After this, the method further includes: determining whether the control terminal is currently in an access state when the alarm clock time arrives, and if yes, playing the song corresponding to the alarm clock information via the wireless music system.

In at least one embodiment, the alarm clock information further includes specified device information in other words, specified information, such as device identification of a playback device. The process of playing the alarm clock bell can be one of the follows: controlling the playback device corresponding to the specified information device information within the wireless music system to play the alarm clock bell; or, controlling the playback device corresponding to the specified information device information within the wireless music system to play the song corresponding to the alarm clock information.

In at least one embodiment, the process of acquiring an identification and alarm clock information of a control terminal automatically upon detecting an access of the control terminal by the wireless music system includes: acquiring the ID of the control terminal upon detecting the access of the control terminal by the wireless music system; and sending a request for acquiring the alarm clock information to the control terminal and receiving the alarm clock information returned from the control terminal.

In at least one embodiment, after the process of storing the association in the wireless music system, the method further includes: deleting the association from the wireless music system if it is determined that the non-access time length of the control terminal with the ID has reached a preset time length.

According to a second aspect of the present disclosure, it is provided a wireless music system, which includes a plurality of playback devices, an alarm clock acquiring unit, and an alarm clock updating unit. The alarm clock acquiring unit is configured to: acquire identification (hereinafter, ID) and alarm clock information of a control terminal automatically upon detecting an access of the control terminal; establish an association between the ID and the alarm clock information and store the association in the wireless music system. The alarm clock updating unit is configured to acquire updated alarm clock information upon detecting an update of the alarm clock information of the control terminal and update the alarm clock information associated with the control terminal in the wireless music system.

According to a third aspect of the present disclosure, it is provided an apparatus, which includes: one or more processors and a memory; wherein one or more programs are stored in the memory, and when executed by the one or more processors, adapted to perform the method for setting an alarm clock of a wireless music system according to the first aspect of the present disclosure.

### BRIEF DESCRIPTION OF THE DRAWINGS

In order to illustrate the technical solutions of the present disclosure or the related art more clearly, a brief description of the accompanying drawings used herein is given below. Obviously, the drawings listed below are only examples, and a person skilled in the art should be noted that, other drawings can also be obtained on the basis of these exemplary drawings without creative work.

FIG. 1 is a structure schematic diagram illustrating a wireless music system of the present disclosure.

FIG. 2 is a flow chart illustrating the method for setting an alarm clock of a wireless music system according to a first embodiment of the present disclosure.

FIG. 3 is a flow chart illustrating the method for setting an alarm clock of a wireless music system according to a second embodiment of the present disclosure.

FIG. 4 is a structure schematic diagram illustrating a system for setting an alarm clock of a wireless music system according to a third embodiment of the present disclosure.

FIG. 5 is a block diagram illustrating an apparatus according to the fifth embodiment of the present disclosure.

### DETAILED DESCRIPTION OF ILLUSTRATED EMBODIMENTS

The technical solutions of the embodiments of the present disclosure will now be described clearly and completely taken in conjunction with the accompanying drawings; it will be apparent to one of ordinary skill in the art that, the embodiments described below are merely a part of the disclosure and other embodiments obtained out of them without creative work will fall into the protection range of the present disclosure either.

### First Embodiment

In this embodiment, a method for setting an alarm clock of a wireless music system is described, which includes: acquiring an identification (hereinafter, ID) and alarm clock information of a control terminal automatically upon detecting an access of the control terminal by the wireless music system; establishing an association between the ID and the alarm clock information and storing the association in the wireless music system; and acquiring updated alarm clock information of the control terminal upon detecting an update of the alarm clock information of the control terminal; updating the alarm clock information associated with the control terminal in the wireless music system.

Refer to FIG. 2 for detailed description. FIG. 2 is a flow chart illustrating the method for setting an alarm clock of a wireless music system according to the first embodiment of the present disclosure. As shown in FIG. 2, the method begins at block 101.

At block 101, identification (hereinafter, ID) and alarm clock information of a control terminal are acquired automatically upon detecting an access of the control terminal by the wireless music system.

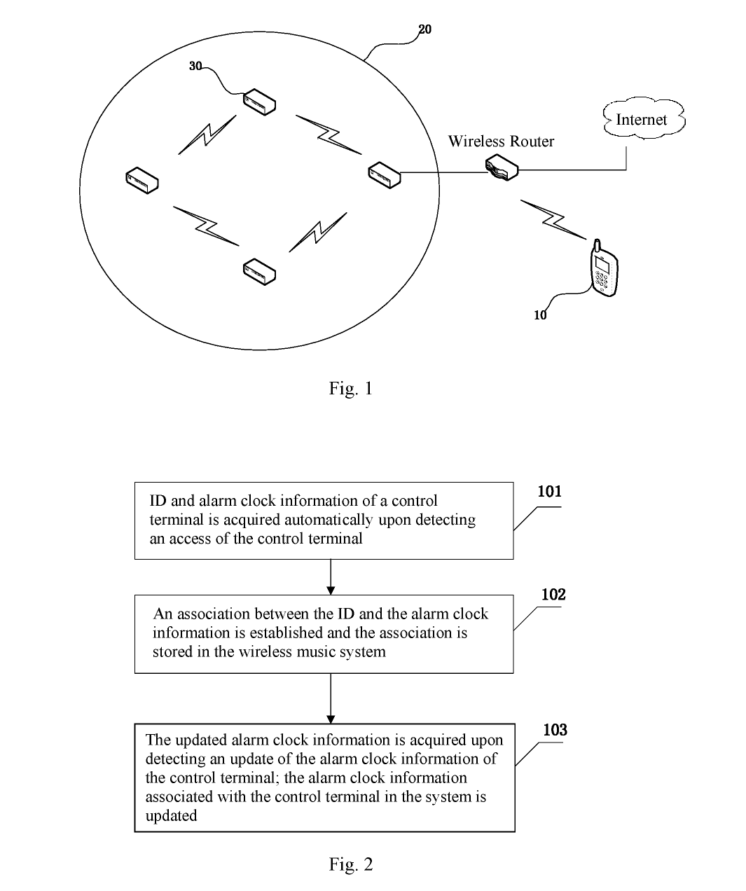

In this embodiment, the structure of the wireless music system can be as shown in FIG. 1, multiple playback devices 30 of the wireless music system 20 are connected to each other wirelessly and an external interface(s) is provided, wherein a connection with the Internet and/or a control terminal can be achieved via the external interface. In addition, other network topologies can also be used in the wireless music system 20, and the disclosure is therefore not limited thereto.

In this embodiment, the control terminal can be one of a smart phone, a tablet computer, and the like. Application software for controlling the wireless music system is pre-installed in the control terminal, and operation instructions can be received via a user interface of the application software, whereby realizing management and control of the wireless music system.

In this embodiment, the playback device can be one of Bluetooth wireless speaker, WiFi wireless speaker, 2.4G wireless speaker, FM wireless speaker, and the like. In at least one embodiment, each playback device within the wireless music system has a unique identifier (such as Equipment number, name, MAC address, and the like.)

In this embodiment, the alarm clock information can be preset at the control terminal by a user; when the user with the control terminal entered into the network area of the wireless music system, the wireless music system will acquire the ID of the control terminal automatically once the access of the control terminal is detected; in addition, the wireless music system can send a request for acquiring the alarm clock information to the control terminal and receive the alarm clock information returned from the control terminal. The ID of the control terminal is used to distinguish multiple control terminals accessing the same wireless music system.

At block 102, an association between the ID and the alarm clock information is established, and the association is stored in the wireless music system.

In the first embodiment, the alarm clock information of multiple control terminals with different IDs can be synchronized to the same wireless music system by establishing the association between the ID and the alarm clock information; besides, within the wireless music system, the alarm clocks corresponding to the multiple control terminals will not interfere with each other.

In this embodiment, the association can be stored in different locations, which will be described in detail below with refer to Examples 1-3, but the present disclosure is not limited thereto.

Example 1: the association can be stored in all of the playback devices within the wireless music system. When the alarm clock time of the association arrives, all or a part of the playback devices will be controlled to conduct alarm clock reminds if a corresponding control terminal is in an access state to the wireless music system, in which situation the alarm clock of the wireless music system will not be invalid or loss even if one or more playback devices are turned off or removed.

Example 2: the association can be stored in a playback system which is used for external connection within the wireless music system, from which other playback devices can acquire the alarm clock information. When the alarm clock time of the association arrives, the playback device can notify a corresponding playback device to conduct alarm clock reminds if the corresponding control terminal is in an access state to the wireless music system.

Example 3: the association can be stored in one or more user-specified playback devices within the wireless music system, for example, stored in the playback device in the main bedroom only; wherein the alarm clock information further includes the specified information device information of a playback device, and when the alarm clock time arrives, the playback device corresponding to the specified information device information within the wireless music system will be controlled to conduct alarm clock reminds if a corresponding control terminal is in an access state to the wireless music system.

It should be noted that, there is no limits as to the process of conducting alarm clock reminds, for example, the wireless music system can use the alarm clock bell set by the control terminal to do this; or, the wireless music system can identify user preferences via the play record of the user and use the song of user preference to do this.

At block 103, updated alarm clock information is acquired upon detecting an update of the alarm clock information of the control terminal; and the alarm clock information associated with the control terminal in the wireless music system is updated. Incidentally, in contradistinction, the user has to set the alarm clock of the wireless music system manually and make sure that the alarm clock information is stored in a specified playback device within the wireless music system in the related art.

In this embodiment, the alarm clock information of the control terminal can be modified by the user after being synchronized to the wireless music system. In this situation, if the control terminal is currently in an access state to the wireless music system, the wireless music system can update the stored association based on the modified alarm clock information, such that the alarm clock of the wireless music system and the alarm clock of the control terminal will remain consistent with each other; on the other hand, if the control terminal is currently in a non-access state to the wireless music system, the modified alarm clock information can be acquired when the control terminal access to the wireless music system next time to update the stored association, such that the alarm clock of the wireless music system and the alarm clock of the control terminal will remain consistent with each other. In the related art, after modifying the alarm clock of the control terminal, if the user forgets to synchronize the modified alarm clock information to the wireless music system, the alarm clock of the wireless music system and the alarm clock of the control terminal will be inconsistent with each other, which is inconvenient for the user. It can be seen that, compared with the related art, the technical solution of this embodiment can maintain the consistency between the alarm clock of the wireless music system and the alarm clock of the control terminal.

Through the technical scheme of the first embodiment, the wireless music system can synchronize the alarm clock information of the control terminal to its own alarm clock automatically when the control terminal accessing to the wireless music system, and update its own alarm clock information in time. Thus, there is no need to set or update the alarm clock of the wireless music system manually by the user, which can avoid the adverse effects caused by untimely update and provide the user with convenience.

### Second Embodiment

Take into account the limited storage space of the wireless music system and the need to shorten the response time of the wireless music system to the alarm clock, on the basis of the first embodiment, an effective time is set for the alarm clock of the wireless music system in the second embodiment, wherein an alarm clock information will be deleted from the system if it already exceeds the effective time so as to free-up storage space and eliminate the impact on the response time of the system to the alarm clock caused by too much association information stored in the wireless music system.

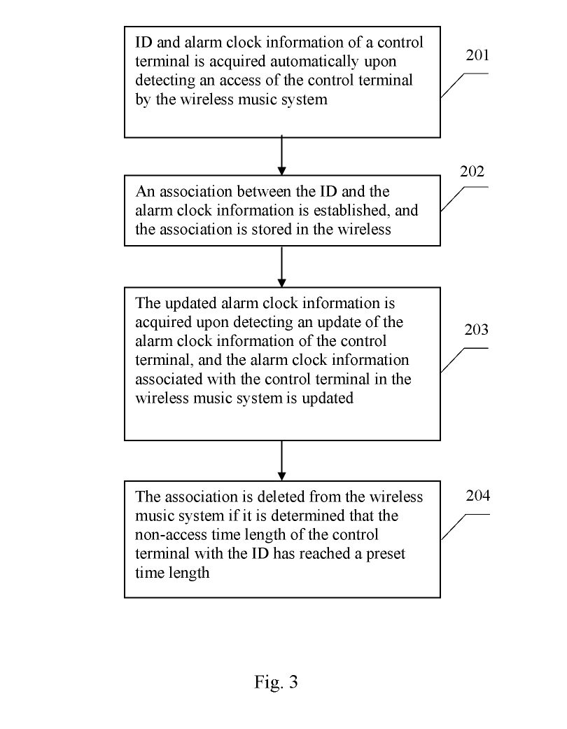

In the following, the second embodiment of the present disclosure will be described in detail with refer to FIG. 3, which is a flow chart illustrating the method for setting an alarm clock of a wireless music system according to the second embodiment. As shown in FIG. 3, the method begins at block 201.

At block 201, identification (hereinafter, ID) and alarm clock information of a control terminal are acquired automatically upon detecting an access of the control terminal by the wireless music system.

At block 201, identification (hereinafter, ID) and alarm clock information of a control terminal are acquired automatically upon detecting an access of the control terminal by the wireless music system.

As described in the first embodiment, the structure of the wireless music system of the second embodiment can be as shown in FIG. 1, multiple playback devices 30 of the wireless music system 20 are connected to each other through wireless mode and an external interface(s) is provided, wherein a connection with the Internet and/or a control terminal can be achieved via the external interface. As mentioned above, the control terminal can be one of a smart phone, a tablet computer, and the like. Application software for controlling the wireless music system is pre-installed in the control terminal, and operation instructions can be received via a user interface of the application software, whereby realizing management and control of the wireless music system. As to the playback device, it can be one of Bluetooth wireless speaker, WiFi wireless speaker, 2.4G wireless speaker, FM wireless speaker, and the like. In at least one embodiment, each playback device within the wireless music system has a unique identifier (such as Equipment number, name, MAC address, and the like.)

In the second embodiment, the alarm clock information can be preset at the control terminal by a user; when the user with the control terminal entered into the network area of the wireless music system, the wireless music system will acquire the ID of the control terminal automatically once the access of the control terminal is detected; thereafter, the wireless system can send a request for acquiring the alarm clock information to the control terminal and receive the alarm clock information returned from the control terminal (that is, ID and alarm clock information of the control terminal is acquired upon detecting the access of the control terminal, as described in block 201). The ID of the control terminal is used to distinguish multiple control terminals accessing the same wireless music system.

At block 202, an association between the ID and the alarm clock information is established, and the association is stored in the wireless music system.

In at least one embodiment, the alarm clock information can include alarm clock time and alarm clock bell, and as described in the first embodiment, after storing the association between the ID and the alarm clock information, the wireless music system will acquire the ID of the currently accessed control terminal in real time, and then find and turn on the alarm clock information associated with the ID. The wireless music system then turns on a corresponding alarm clock according to the alarm clock information. Thereafter, the wireless music system will determine whether the control terminal is currently in an access state; if yes, the alarm clock bell will be played via the wireless music system when the alarm clock arrives; more specifically, if the alarm clock information further comprises specified information device information of a playback device, the playback device corresponding to the specified information device information within the wireless music system will be controlled to play the alarm clock bell. That is to say, the wireless music system will play the alarm clock bell being set at the control terminal to conduct alarm clock reminds, in other words, the wireless music system can play the same alarm clock bell with the smart terminal of the user; otherwise, the alarm clock information will be ignored and there will be no reminder.

In at least one alternative embodiment, the alarm clock information can include alarm clock time, but no alarm clock bell is included here. Corresponding to this, the wireless music system will inquire the historical play record corresponding to the ID stored in the system, and find the most-played song of the control terminal with the ID in the wireless music system, that is to say, identify the song of user preference of the control terminal according to the historical play record. Thereafter, the wireless music system will establish a corresponding relationship between the song and the alarm clock information, and store the association and the corresponding relationship therein (that is, the association is stored in the wireless music system, as described in block 202). Then the wireless music system will acquire the ID of the currently accessed control terminal in real time and determine whether the control terminal is currently in an access state; if yes, when the alarm clock time arrives, the identified song of user preference will be played via the wireless music system to conduct alarm clock reminds, more specifically, if the alarm clock information further comprises specified information device information of a playback device, the playback device corresponding to the specified information device information within the wireless music system will be controlled to play the song; otherwise, the alarm clock information will be ignored and there will be no reminder.

One example is that, according to the historical play record of User A, it is found that most of the songs played by User A recently are English song, then at the time of synchronizing the alarm clock information of the smart phone of User A, the wireless music system will configure the most-played English song to be the alarm clock bell of the alarm clock. In at least one embodiment, the historical play record can be set to be the play record of last month. Through this alarm clock setting mode, the most recent favorite songs of the user can be identified according to the update of the play record of the user, such that the song used for alarm clock reminds can be updated in real time, which is more user-friendly and intelligent.

In order to better understand the technical solution of the embodiment, a specific example is provided in the following, in which there is an alarm clock setting of 8 a.m. in the smart phone of the user. When the smart phone is connected with the wireless music system, the alarm clock information will be synchronized to the wireless music system automatically, that is to say, an alarm clock of 8 a.m. will be added to the wireless music system automatically, in other words, the wireless music system will play a corresponding song or corresponding alarm clock bell at 8 a.m. automatically.

In this embodiment, when control terminals of multiple users using the same wireless music system, all the alarm clock information thereof will be recorded, stored, and applied by the wireless music system respectively. Each user can specify the playback devices within the wireless music system to which the alarm clock will be applied without interfering with each other. For example, User A can specify that the alarm clock of his or her smart phone be applied to the playback device in bedroom 1, and User B can specify that the alarm clock of his or her smart phone be applied to the playback device in bedroom 2 only.

At block 203, updated alarm clock information is acquired upon detecting an update of the alarm clock information of the control terminal, and the alarm clock information associated with the control terminal in the wireless music system is updated. In contradistinction, the user has to set the alarm clock of the wireless music system manually and make sure that the alarm clock information is stored in a specified playback device within the wireless music system in the related art.

In this embodiment, if the control terminal is currently in an access state to the wireless music system, the system can update the stored association based on the modified alarm clock information; on the other hand, if the control terminal is currently in a non-access state to the wireless music system, the system can acquire the modified alarm clock information when the control terminal accessing to it next time so as to update the stored association. For example, there is an alarm clock of 8 a.m. in the control terminal, which is synchronized to the wireless music system today and will be modified to be of 9 a.m. the next day, the modified alarm clock information will be synchronized to the wireless music system automatically once the control terminal access to the system. In the related art, after modifying the alarm clock of the control terminal, if the user forgets to synchronize the modified alarm clock information to the wireless music system, the alarm clock of the wireless music system and the alarm clock of the control terminal will be inconsistent with each other, which is inconvenient for the user. Compared with the related art, the technical solution of this embodiment can maintain the consistency between the alarm clock of the wireless music system and the alarm clock of the control terminal.

At block 204, the association is deleted from the wireless music system if it is determined that the non-access time length of the control terminal with the ID has reached a preset time length.

In this embodiment, for example, the preset time length is 48 hours, that is to say, if the control terminal has not access to the wireless music system for up to 48 hours, the alarm clock setting of the control terminal will be deleted from the wireless music system. When the control terminal accessing to the wireless music system again, the alarm clock of the control terminal will be re-synchronized and applied to the wireless music system.

By means of the second embodiment, when the control terminal accessing to the wireless music system, the system will set the alarm clock information of the control terminal to be the alarm clock of its own synchronously so as to update the alarm clock information in time. Thus, there is no need to set or update the alarm clock of the wireless music system manually by the user, which can avoid the adverse effects caused by untimely update and provide the user with convenience. Besides, an alarm clock of a control terminal will be deleted from the wireless music system if it is detected that the control terminal had not accessed to the system for a preset time length, so as to free-up storage space and shorten the response time of the system to the alarm clock.

### Third Embodiment

The third embodiment of the present disclosure relates to a wireless music system, which belongs to the same conception as the method embodiments as described above. For the un-illustrated details, please refer to the above-mentioned method embodiments.

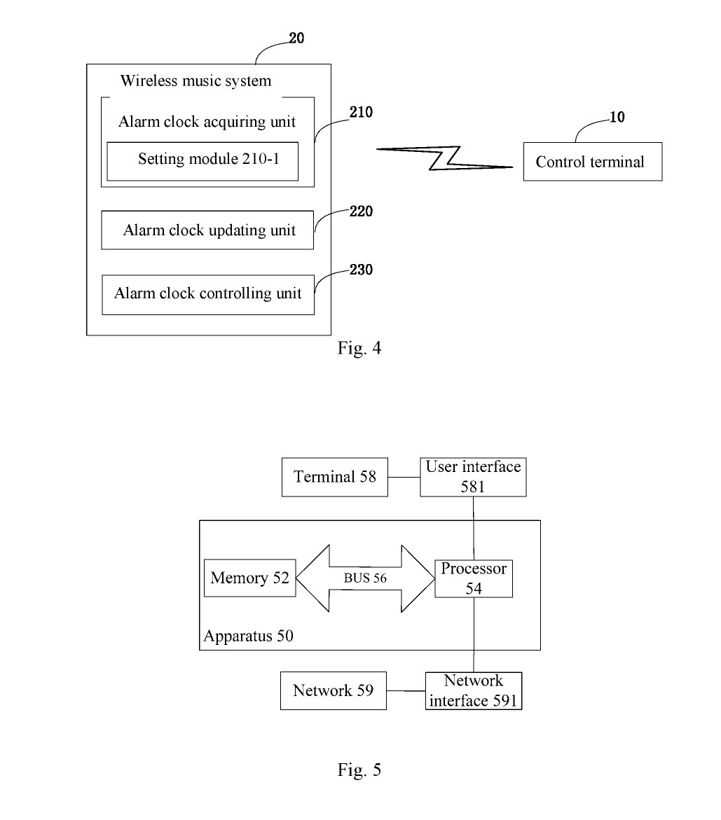

The wireless music system according to the third embodiment will now be described in detail with refer to FIG. 4, which is a structure schematic diagram illustrating the system.

As shown in FIG. 1 and FIG. 4, the wireless music system 20 includes a plurality of playback devices 30, an alarm clock acquiring unit 210, and an alarm clock updating unit 220. The multiple playback devices 30 can be connected to each other wirelessly. The alarm clock acquiring unit 210 is configured to: acquire identification (hereinafter, ID) and alarm clock information of a control terminal automatically upon detecting an access of the control terminal; establish an association between the ID and the alarm clock information and store the association in the wireless music system. The alarm clock updating unit 220 is configured to acquire updated alarm clock information upon detecting an update of the alarm clock information of the control terminal and update the alarm clock information associated with the control terminal in the wireless music system.

For purpose of explanation and not limitation, a control terminal 10 is also illustrated in FIG. 4, wherein the control terminal 10 and the wireless music system 20 are connected to each other through a wireless network. Specifically, the control terminal 10 can be one of a smart phone, a tablet computer, and the like, and the playback device 30 can be one of Bluetooth wireless speaker, WiFi wireless speaker, 2.4G wireless speaker, FM wireless speaker, and the like.

The alarm clock acquiring unit 210 and the alarm clock updating unit 220 will now be described below in detail respectively. As an implementation, the alarm clock acquiring unit 210 and the alarm clock updating unit 220 can be implemented through one or more processors, for example, the alarm clock acquiring unit 210 and the alarm clock updating unit 220 can be integrated in one processor, or, can be distributed among different processors.

The alarm clock acquiring unit 210 is configured to: acquire ID and alarm clock information of the control terminal 10 automatically upon detecting an access of the control terminal 10; establish an association between the ID and the alarm clock information, and store the association in the wireless music system.

In this embodiment, the control terminal 10 has preset alarm clock information and a unique ID. Upon detecting the access of the control terminal 10, the alarm clock acquiring unit 210 can acquire the ID of the control terminal 10 at the first place; and send a request for acquiring the alarm clock information to the control terminal 10 and receive the alarm clock information returned from the control terminal 10.

In this embodiment, the alarm clock information of multiple control terminals with different IDs can be synchronized to the same wireless music system by establishing the association between the ID and the alarm clock information; besides, within the wireless music system, the alarm clocks corresponding to the multiple control terminals will not interfere with each other.

In this embodiment, the association can be stored in different locations, which will be described in detail below with refer to Examples 1-3, but the present disclosure is not limited thereto.

Example 1: the association can be stored in all of the playback devices within the wireless music system. When the alarm clock time of the association arrives, all or a part of the playback devices will be controlled to conduct alarm clock reminds if a corresponding control terminal is in an access state to the wireless music system, in which situation the alarm clock of the wireless music system will not be invalid or loss even if one or more playback devices are turned off or removed.

Example 2: the association can be stored in a playback system which is used for external connection within the wireless music system, from which other playback devices can acquire the alarm clock information. When the alarm clock time of the association arrives, the playback device can notify a corresponding playback device to conduct alarm clock reminds if the corresponding control terminal is in an access state to the wireless music system.

Example 3: the association can be stored in one or more user-specified playback devices within the wireless music system, for example, stored in the playback device in the main bedroom only; wherein the alarm clock information further includes the specified information device information of a playback device and when the alarm clock time arrives, the playback device corresponding to the specified information device information within the wireless music system will be controlled to conduct alarm clock reminds if a corresponding control terminal is in an access state to the wireless music system.

In at least one embodiment, the alarm clock information includes alarm clock time and alarm clock bell, and the wireless music system 20 further includes: an alarm clock controlling unit 230, configured to acquire the ID of the currently accessed control terminal, and find and turn on the alarm clock information associated with the ID. The wireless music system then turns on a corresponding alarm clock according to the alarm clock information. The alarm clock bell will be played via the wireless music system when the alarm clock time arrives. The alarm clock information can further include specified information device information of a playback device, and the alarm clock controlling unit 230 is specifically configured to acquire the ID of the currently accessed control terminal so as to determine whether the control terminal is currently in an access state; if yes, when the alarm clock time arrives, control the playback device corresponding to the specified information device information within the wireless music system to play the alarm clock bell; otherwise, the alarm clock information will be ignored and there will be no reminder.

Specifically, as to the alarm clock controlling unit 230, it can be a controller, which is connected to the processor in a wired or wireless manner and is used to control and coordinate the communications and actions of the entire system.

In at least one embodiment, the alarm clock information can include alarm clock time. Corresponding to this, the alarm clock acquiring unit 210 includes a setting module 210-1 (for example, a setter within the processor), which is configured to inquire the historical play record corresponding to the ID stored in the system and find the most-played song of the control terminal with the ID in the wireless music system, thereafter, establish a corresponding relationship between the song and the alarm clock information and store the association and the corresponding relationship in the wireless music system.

The clock controlling unit 230 is further configured to: acquire the ID of the currently accessed control terminal, find and turn on the alarm clock information associated with the ID; turn on a corresponding alarm clock according to the alarm clock information; and play the alarm clock bell via the wireless music system when the alarm clock time arrives.

Alternatively, the alarm clock information can include specified information device information of a playback device. Here, the alarm clock controlling unit 230 is configured to: acquire the ID of the currently accessed control terminal to determine whether the control terminal is in an access state; and if yes, control the playback device corresponding to the specified information device information in the wireless music system to play the alarm clock bell when the alarm clock time arrives; otherwise, the alarm clock information will be ignored and there will be no reminder.

In at least one embodiment, the historical play record can be the play record of last month.

The alarm clock updating 220 is configured to acquire updated alarm clock information upon detecting an update of the alarm clock information of the control terminal, and update the alarm clock information associated with the control terminal in the wireless music system.

In this embodiment, the alarm clock information of the control terminal can be modified by the user after being synchronized to the wireless music system. In this situation, if the control terminal is currently in an access state to the wireless music system, the wireless music system can update the stored association based on the modified alarm clock information; otherwise, if the control terminal is currently in a non-access state to the wireless music system, the modified alarm clock information can be acquired when the control terminal access to the wireless music system next time to update the stored association. On the contrary, in the related art, after modifying the alarm clock of the control terminal, if the user forgets to synchronize the modified alarm clock information to the wireless music system, the alarm clock of the wireless music system and the alarm clock of the control terminal will be inconsistent with each other, which is inconvenient for the user.

Through the third Embodiment as described above, the wireless music system can synchronize the alarm clock information of the control terminal to its own alarm clock automatically when the control terminal accessed to the wireless music system, and update its own alarm clock information in time, such that the alarm clock of the wireless music system and the alarm clock of the control terminal will remain consistent with each other.

### Fourth Embodiment

Take into account the limited storage space of the wireless music system and the need to shorten the response time of the wireless music system to the alarm clock, on the basis of the third embodiment, the alarm clock updating unit 220 of the wireless music system 20 according to the fourth embodiment is further configured to: delete the association from the wireless music system if it is determined that the non-access time length of the control terminal 10 with the ID has reached a preset time length.

As one example, the preset time length is 48 hours, that is to say, if the control terminal has not accessed to the wireless music system for up to 48 hours, the alarm clock setting of the control terminal will be deleted from the wireless music system. When the control terminal accessing to the wireless music system again, the alarm clock of the control terminal will be re-synchronized and applied to the wireless music system.

Through the fourth embodiment as described above, when the access to the wireless music system of the control terminal is detected, the system will synchronize the alarm clock information of the control terminal automatically so as to update the alarm clock information of the wireless music system in time, such that the alarm clock of the wireless music system and the alarm clock of the corresponding control terminal will remain synchronized with each other, and the wireless music system can maintain the system alarm clock based on the access of the control terminal, which provides convenience for the user.

### Fifth Embodiment

According to the fifth embodiment of the present disclosure, it is provided an apparatus. FIG. 5 is a block diagram illustrating the apparatus. As shown in FIG. 5, the apparatus 50 includes a memory 52 and at least one processor 54 (for clarity, only one is illustrated in the figure). Wherein the memory 52 and the processor 54 can be connected in a wired or wireless manner, for example, through a bus 56. For example, the apparatus 50 of the embodiment can be a server in communicate with a wireless music system, or, can be a computing device built in the wireless music system.

To be specific, the memory 52 is configured to store computer-readable program code, and can be ROM, RAM, CD-RAM, or any other removable storage medium; the processor 54 is configured to invoke the computer-readable program code stored in the memory 52 to execute predetermined process such as the methods described above, to avoid unnecessarily obscuring the present invention, the details of the methods or process will not be provided here. In addition, as shown in FIG. 5, the processor 54 can but not necessarily connect to a terminal 58 through a user interface 581 or to a network 59 through a network interface 591. Alternatively, the processor can also connect to the outside terminal or network in a wireless manner.

### Sixth Embodiment

According to the sixth embodiment of the disclosure, it is provided a computer-readable storage medium configured to store computer-readable program code, when executed on a data-processing apparatus, adapted to perform the methods as described in the above-mentioned embodiments.

The computer-readable storage medium may be referred to as a non-volatile computer-readable storage medium or tangible computer-readable medium. Examples of computer-readable storage medium include but are not limited to: magnetic hard disk drive, solid state hard disk, flash memory, USB thumb drive, RAM, ROM, magneto-optical disk, and the register file of the processor.

The term computer readable-storage medium also refers to various types of recording media capable of being accessed by the computer device via a network or communication link. For example, data may be retrieved over a modem, over the internet, or over a local area network. References to a computer-readable storage medium should be interpreted as possibly being multiple computer-readable storage mediums. For example, the computer-readable storage medium can be multiple computer-readable storage medium within the same computer system, or, can be computer readable storage medium distributed among multiple computer systems or computing devices.

Through the technical schemes of the embodiments of the present disclosure as described above, that is, by acquiring the ID and alarm clock information of the control terminal automatically upon detecting the access of the control terminal by the wireless music system, establishing an association between the ID and the alarm clock information and storing the association in the wireless music system, and deleting the association from the wireless music system if it is determined that the non-access time length of the control terminal with the ID has reached a preset time length, at least the following beneficial effects can be achieved: the alarm clock information in the control terminal can be synchronized to the wireless music system automatically when the control terminal accessing to the wireless music system, and the alarm clock information of the wireless music system can be updated in time, which makes the setting of the alarm clock of the wireless music system more convenient and reliable.

The foregoing descriptions are merely exemplary embodiments of the present disclosure, rather than limiting the present disclosure. Various modifications and alterations may be made to the present disclosure for those skilled in the art. Any modification, equivalent substitution, improvement or the like made within the spirit and principle of the present disclosure shall fall into the protection scope of the present disclosure.

What is claimed is:

1. A method for setting an alarm clock of a wireless music system, comprising:
acquiring an identification and alarm clock information of a control terminal automatically upon detecting an access of the control terminal by the wireless music system;
establishing an association between the identification and the alarm clock information and storing the association in the wireless music system; and
acquiring updated alarm clock information of the control terminal upon detecting an update of the alarm clock information of the control terminal, and updating the alarm clock information associated with the control terminal in the wireless music system.

2. The method for setting an alarm clock of a wireless music system of claim 1, wherein the alarm clock information comprises alarm clock time and alarm clock bell; after storing the association in the wireless music system, the method further comprises:
determining whether the control terminal is currently in an access state when the alarm clock time arrives, and if yes, playing the alarm clock bell via the wireless music system.

3. The method for setting an alarm clock of a wireless music system of claim 1, wherein the alarm clock information comprises alarm clock time; storing the association in the wireless music system comprises:
inquiring a historical play record corresponding to the identification stored in the wireless music system, and finding the most-played song of the control terminal with the identification in the wireless music system; and
establishing a corresponding relationship between the most-played song and the alarm clock information, and storing the association and the corresponding relationship in the wireless music system;
and after storing the association and the corresponding relationship in the wireless music system, the method further comprises: determining whether the control terminal is currently in an access state when the alarm clock time arrives, and if yes, playing the most-played song corresponding to the alarm clock information via the wireless music system.

4. The method for setting an alarm clock of a wireless music system of claim 2, wherein the alarm clock information further comprises device information of a playback device;
playing the alarm clock bell via the wireless music system comprises: controlling the playback device corresponding to the device information within the wireless music system to play the alarm clock bell.

5. The method for setting an alarm clock of a wireless music system of claim 3, wherein the alarm clock information further comprises device information of a playback device;
playing the most-played song corresponding to the alarm clock information via the wireless music system comprises: controlling the playback device corresponding to the device information within the wireless music system to play the most-played song corresponding to the alarm clock information.

6. The method for setting an alarm clock of a wireless music system of claim 1, wherein acquiring an identification and alarm clock information of the control terminal automatically upon detecting an access of the control terminal by the wireless music system comprises:
acquiring the identification of the control terminal upon detecting the access of the control terminal by the wireless music system; and
sending a request for acquiring the alarm clock information to the control terminal, and receiving the alarm clock information returned from the control terminal.

7. The method for setting an alarm clock of a wireless music system of claim 1, wherein after storing the association in the wireless music system, the method further comprises:
deleting the association from the wireless music system if it is determined that a non-access time length of the control terminal with the identification has reached a preset time length.

8. A wireless music system comprising:
a plurality of playback devices;
an alarm clock acquiring unit, configured to: acquire identification and alarm clock information of a control terminal automatically upon detecting an access of the control terminal; and establish an association between the identification and the alarm clock information and store the association in the wireless music system; and
an alarm clock updating unit, configured to: acquire updated alarm clock information upon detecting an update of the alarm clock information of the control terminal; and update the alarm clock information associated with the control terminal in the wireless music system.

9. The wireless music system of claim 8, wherein the alarm clock information comprises alarm clock time and alarm clock bell; the wireless music system further comprises an alarm clock controlling unit, which is configured to: acquire the identification of the currently accessed control terminal, find the alarm clock information associated with the identification, turn on a corresponding alarm clock according to the alarm clock information; and play the alarm clock bell via the wireless music system when the alarm clock time arrives.

10. The wireless music system of claim 8, wherein the alarm clock information comprises alarm clock time; the alarm clock acquiring unit comprises a setting module, which is configured to: inquire a historical play record corresponding to the identification stored in the wireless music system, find the most-played song of the control terminal with the identification in the wireless music system; and establish a corresponding relationship between the most-played song and the alarm clock information, and store the association and the corresponding relationship in the wireless music system;
the wireless music system further comprises an alarm clock controlling unit, which is configured to: determine whether the control terminal is currently in an access state when the alarm clock time arrives, and if yes, play the most-played song corresponding to the alarm clock information via the wireless music system.

11. The wireless music system of claim 9, wherein the alarm clock information further comprises device information of a playback device; and the alarm clock controlling unit is configured to: determine whether the control terminal is currently in an access state when the alarm clock time arrives; and if yes, control the playback device corresponding to the device information within the wireless music system to play the alarm clock bell.

12. The wireless music system of claim 10, wherein the alarm clock information further comprises device information of a playback device; the alarm clock controlling unit is configured to: acquire the identification of the currently accessed control terminal, find the alarm clock information associated with the identification, turn on a corresponding alarm clock according to the alarm clock information; and control the playback device corresponding to the device information within the wireless music system to play the most-played song corresponding to the alarm clock information when the alarm clock time arrives.

13. The wireless music system of claim 8, wherein the alarm clock acquiring unit comprises a setting module, which is configured to: acquire the identification of the control terminal upon detecting the access of the control terminal; and send a request for acquiring the alarm clock information to the control terminal and receive the alarm clock information returned from the control terminal.

14. The wireless music system of claim 8, wherein the alarm clock updating unit is further configured to delete the association from the wireless music system if it is determined that a non-access time length of the control terminal with the identification has reached a preset time length.

15. The wireless music system of claim 9, wherein the alarm clock updating unit is further configured to delete the association from the wireless music system if it is determined that a non-access time length of the control terminal with the identification has reached a preset time length.

16. An apparatus, comprising:
one or more processors;
a memory; and
one or more programs stored in the memory, when executed by the one or more processors, adapted to perform predetermined process:
acquiring an identification and alarm clock information of a control terminal automatically upon detecting an access of the control terminal;
establishing an association between the identification and the alarm clock information and storing the association; and
acquiring updated alarm clock information of the control terminal upon detecting an update of the alarm clock information of the control terminal, and updating the stored alarm clock information associated with the control terminal.

17. The apparatus of claim 16, wherein the alarm clock information comprises alarm clock time and alarm clock bell, and the predetermined process further comprises:
determining whether the control terminal is currently in an access state when the alarm clock time arrives, and if yes, playing the alarm clock bell.

18. The apparatus of claim 16, wherein the alarm clock information comprises alarm clock time;
storing the association comprises:
inquiring a historical play record corresponding to the identification, and finding the most-played song of the control terminal with the identification; and
establishing a corresponding relationship between the most-played song and the alarm clock information, and storing the association and the corresponding relationship;
and the predetermined process further comprises:
determining whether the control terminal is currently in an access state when the alarm clock time arrives, and if yes, playing the most-played song corresponding to the alarm clock information.

19. The apparatus of claim 17, wherein the alarm clock information further comprises device information of a playback device;
playing the alarm clock bell comprises: controlling the playback device corresponding to the device information to play the alarm clock bell.

20. The apparatus of claim 18, wherein the alarm clock information further comprises device information of a playback device;
playing the most-played song corresponding to the alarm clock information comprises: controlling the playback device corresponding to the device information to play the most-played song corresponding to the alarm clock information.
